(19) United States
(12) Patent Application Publication
(10) Pub. No.: US 2009/0086355 A1
(43) Pub. Date: Apr. 2, 2009

(54) SPINDLE STAGE FOR TESTING MAGNETIC HEAD WITH VCM MECHANISM AND AUTOMATIC MAGNETIC HEAD MOUNTING/DEMOUNTING DEVICE

(75) Inventors: Kei Ohno, Kanagawa (JP); Tomoki Adachi, Kanagawa (JP)

Correspondence Address: MCCORMICK, PAULDING & HUBER LLP, CITY PLACE II, 185 ASYLUM STREET, HARTFORD, CT, 06103, US

(73) Assignee: International Manufacturing and Engineering Services Co., Ltd., Fujisawa-shi, Kanagawa (JP)

(21) Appl. No.: 12/295,123

(22) PCT Filed: Dec. 25, 2006
(86) PCT No.: PCT/JP2006/325709

§ 371 Date: Sep. 29, 2008

(30) Foreign Application Priority Data
Mar. 30, 2006 (JP) 2006-093813

(51) Int. Cl. G11B 27/36

(52) U.S. Cl. 360/31

(57) ABSTRACT

To provide a spindle stage for testing a magnetic head in which high precision servo following can be performed by an inexpensive VCM mechanism without using a piezoelectric element, and to provide a device for mounting/demounting a magnetic head automatically. In a spindle stage for testing a magnetic head which includes: a head arm device having a head arm portion which is driven to swing by a VCM mechanism; and an HGA attached to the head arm portion, and loads the head arm device and the HGA relative to a surface of a medium in rotation to measure the electrical and mechanical characteristics, wherein the spindle stage includes: a fitting portion in which a swaging boss of the HGA is removably fitted; and a clamping member which moves between a locking position in which the swaging boss fitted in the fitting portion is locked and a releasing position in which the swaging boss can be freely fitted and removed into and from the fitting portion.

### CROSS REFERENCE TO RELATED APPLICATIONS

This application is entitled to the benefit of and incorporates by reference essential subject matter disclosed in International Patent Application No. PCT/JP2006/325709 filed on Dec. 25, 2006 and Japanese Patent Application No. 2006-93813 filed Mar. 30, 2006.

### FIELD OF THE INVENTION

The present invention relates to a spindle stage for testing a magnetic head with a VCM (voice coil motor) mechanism, and an automatic magnetic head mounting/demounting device.

### BACKGROUND OF THE INVENTION

HGA (Head Gimbal Assembly) which is incorporated into a conventional hard disk drive (magnetic disk drive) has been tested for data reading/writing operations of the reading and writing heads (hereinafter referred to as “reading/writing head”) of the HGA before incorporated into the hard disk drive. In a data read/write test on a magnetic head, the test needs to be carried out as a reading/writing head is positioned precisely at a target position on an unformatted medium (magnetic disk). Accordingly, in conventional spindle stages for testing a magnetic head, a manner of testing the magnetic head wherein the spindle stage is generally provided with a piezo stage with a high positioning resolution and wherein a positioning operation for positioning the magnetic head is carried out with the magnetic head being mounted to the piezo stage has been adopted (Japanese unexamined patent publication 2002-214374).

### DISCLOSURE OF THE INVENTION

However, in conventional piezo stages, the following problems are known in the art: the piezo stage cannot sufficiently follow positional variations due to NRRO (Non-Repeatable Run-Out) that accompanies the rotation of a magnetic disc, and positional variations occur by temperature drift. In addition, since the piezo stage basically moves linearly, there has been an issue that it is difficult to vary the skew angle seamlessly by making the head perform a seek operation on a medium, just like an actual hard disk drive. Moreover, the piezo stage is expensive.

In next generation media in which a servo pattern is prewritten, it is essential that the test be performed as servo following is performed; however, it has been difficult to mount and demount HGA in those testing devices which remove the influence of NRRO while following the prewritten servo pattern and which perform a track following while appropriately changing the skew angle.

The present invention has been devised in view of the above described problems of conventional technologies, and objects of the present invention are to provide a spindle stage for testing a magnetic head in which a high-precision servo following can be performed by an inexpensive VCM mechanism without using a piezoelectric element and to provide a device for mounting/demounting a magnetic head automatically.

A spindle stage for testing a magnetic head according to the present invention which achieves the aforementioned objects is a spindle stage for testing a magnetic head which includes: a head arm device having a head arm portion which is driven to swing by a VCM mechanism; and an HGA mounted to the head arm portion, and loads the head arm device and the HGA relative to a surface of a medium in rotation to measure the electrical and mechanical characteristics, wherein the spindle stage is characterized in that it includes: a fitting portion in which a swaging boss of the HGA is removably fitted; and a clamping member which moves between a locking position in which the swaging boss fitted in the fitting portion is locked and a releasing position in which the swaging boss can be freely fitted and removed into and from the fitting portion.

The clamp member is formed into a clamp lever having a claw portion formed to be movable between a releasing position in which the HGA is allowed to be mounted and demounted and an engaging position in which the claw portion engages with the HGA to lock the swaging boss relative to the fitting portion, and wherein the clamp lever includes a resilient member which biases the claw portion to rotate in a direction toward the engaging position. Selections of a length of the clamp lever and a resilient member which biases the clamp lever to rotate make it easy to select a resonant frequency characteristic of a moving part.

More practically, the spindle stage includes a contact base on which a plurality of electrical contacts are mounted, the plurality of electrical contacts being arranged at one end of an FPC drawn from the HGA installed to the head arm portion, wherein the contact base includes a contact lever which is movable between a connecting position in which the contact lever holds the plurality of electrical contacts and a disconnecting position in which the contact lever is disengaged from the plurality of electrical contacts, and wherein the contact lever includes a plurality of electrical contacts which are connected to the plurality of electrical contacts arranged at the one end of the FPC.

Since the connector which is connected to the FPC drawn from the HGA is provided outside of the head arm portion: outside of a movable part, it becomes possible to achieve a further reduction in weight of the head arm portion and an improvement in following performance by the VCM mechanism; moreover, the electrical contacts can be easily connected and disconnected.

In a more desirable embodiment, the spindle stage includes a movable base plate on which the head arm device and the contact base are mounted, wherein the movable base plate moves the head arm device and the contact base as one piece between an unloading position in which the HGA is unloaded outside of the medium and a loading position in which the HGA is loaded on the medium. By moving the head arm device and the contact base between the loading position and the unloading position, the range of following operation of the head arm portion can be narrow, and the head arm portion is not influenced by the FPC when the head arm portion is moved between the loading position and the unloading position.

The head arm device further includes a limit mechanism for limiting the range of movement of the VCM mechanism. In addition, it is desirable that the limit mechanism be composed of a limit projection which projects from a coil arm portion to which the VCM mechanism is mounted, and two limit members arranged on opposite sides of the coil arm portion, at least one of the two limit members being formed to be movable in a direction to adjust the range of movement of the VCM mechanism.

According to this configuration, the range of movement of the VCM mechanism is limited, the range of movement of the FPC can be narrow, and there is no possibility of a poor connection occurring between the FPC and the connector by an excessive deflection of the VCM mechanism and the head arm portion when the head arm device is moved via the movable plate from the unloading position to the loading position.

The spindle stage includes a ramp member having a ramp surface, wherein the ramp surface makes a tip of the HGA move onto the ramp surface and moves the magnetic head gradually away from a surface of the medium in rotation before the magnetic head moves off the medium when the movable base plate moves in a direction toward the unloading position, makes the tip move away from the ramp surface when the movable base plate is in the unloading position, makes the tip move onto the ramp surface and moves the magnetic head in a direction away from the surface of the medium before the magnetic head reaches the surface of the ramp when the movable base plate moves from the unloading position toward the loading position, and thereafter makes the magnetic head gradually approach the surface of the medium and subsequently move away from the surface of the medium before reaching the loading position. Even if the HGA is of a type including a suspension portion which bends largely outside the medium, the HGA can be unloaded to the unloading position outside the medium; moreover the HGA can be loaded to a surface level of the medium from the unloading position, and accordingly, the HGA can be easily mounted and demounted when in the unloading position.

The head arm device is formed so that an outside of a downstream side in a direction of rotation of the medium in rotation becomes the unloading position. According to this configuration, the head arm device can be made adaptable to both a type of HGA which is loaded to a lower surface of the medium and another type of HGA which is loaded to an upper surface of the medium with a minor modification to the head arm device, and the HGA can be mounted and demounted from above the head arm device in either type of HGA.

An automatic magnetic head mounting/demounting device according to the present invention which is applied to the spindle stage for testing a magnetic head is characterized in that the automatic magnetic head mounting/demounting device includes a suction portion which sucks and holds the HGA to be capable of freely holding/releasing the HGA, and a release member which presses the clamp member of the head arm portion to rotate the clamp member to the releasing position against the resilient biasing member, wherein the loading head is configured so that the release member presses the clamp member against the resilient biasing member to rotate the clamp member in the releasing position before the loading head makes the HGA which is sucked and held by the suction portion fitted into the fitting portion, so that the release member releases the clamp member to thereby rotate the clamp member to an engaging position by a biasing force of the resilient biasing member to lock the HGA by a locking portion and so that the suction portion stops sucking and holding the HGA to be disengaged therefrom. Since the mechanism for installing and removing the HGA to and from the head arm portion is composed of an engagement of the swaging boss with said fitting portion and a release of the clamp member and, the structure of the loading head is simple and automation can be easily introduced.

More practically, the loading head is mounted to a movable arm which is freely movable in the vertical and lateral directions, and the loading head is moved to a position in which the loading head sucks and holds the HGA placed on a supply tray and also to the head arm portion at the unloading position by the movable arm.

### BRIEF DESCRIPTION OF THE DRAWINGS

FIG. 1 shows an example of a magnetic head (HGA) which is tested and measured by a device according to the present invention, wherein (A) is a plan view, (B) is a side view in a loaded state, and (C) is a side view in an unloaded state;

FIG. 2 is a plan view showing an embodiment of an VCM mechanism;

FIG. 3 shows a main part of the VCM mechanism, wherein (A) is a side view of the main part and (B) is a side view of the main part with the leaf spring of the head arm of the main part being depressed;

FIG. 4 is an enlarged plan view of a main part of the embodiment of the VCM mechanism according to the present invention;

FIG. 5 shows the main part of the VCM mechanism by enlarging the same, wherein (A) is a side view of the main part and (B) is a side view of the main part with the leaf spring of the head arm of the main part being depressed;

FIG. 6 shows perspective views schematically showing a structure for mounting and demounting the head arm and the HGA, wherein (A) is a perspective view viewed from above and (B) is a perspective view viewed from below;

FIG. 7 shows, by diagrams (A) through (D), a main part of an embodiment of a device for mounting and demounting the HGA to and from the head arm in different states;

FIG. 8 is a plan view of the head arm and a peripheral portion thereof, showing a connecting structure for connecting reading/writing signal terminals of the HGA mounted to the head arm;

FIG. 9 shows the connecting structure, wherein (A) is a side view in a released state and (B) is a side view in a connected state;

FIG. 10 shows an embodiment of the head arm mounted to a coarse-moving actuator for moving the head arm between an unloading position and a loading position, wherein (A) is a plan view and (B) is a side view;

FIG. 11 is a plan view showing the small range of movement of the head arm on the coarse-moving actuator;

FIG. 12 is a plan view illustrating a manner of moving the head arm between the unloading position and the loading position by the coarse-moving actuator;

FIG. 13 shows a state where a ramp structure is mounted to the aforementioned coarse-moving actuator, wherein (A) is a plan view and (B) is a side view;

FIG. 14 is a side view illustrating the relationship between the load/unload tab and the slider of the HGA configured according to the ramp structure;

FIG. 15 shows the structure of the medium and the head arm device in the case where the device according to the present invention is applied to a magnetic head for reading and writing on the lower surface of the medium, wherein (A) is a plan view and (B) is a view viewed from right side; and

FIG. 16 shows the structure of the medium and the head arm device in the case where the device according to the present invention is applied to a magnetic head for reading and writing on the upper surface of the medium, wherein (A) is a plan view and (B) is a view viewed from right side.

### DETAILED DESCRIPTION OF THE PREFERRED EMBODIMENTS

### Magnetic Head

### HGA

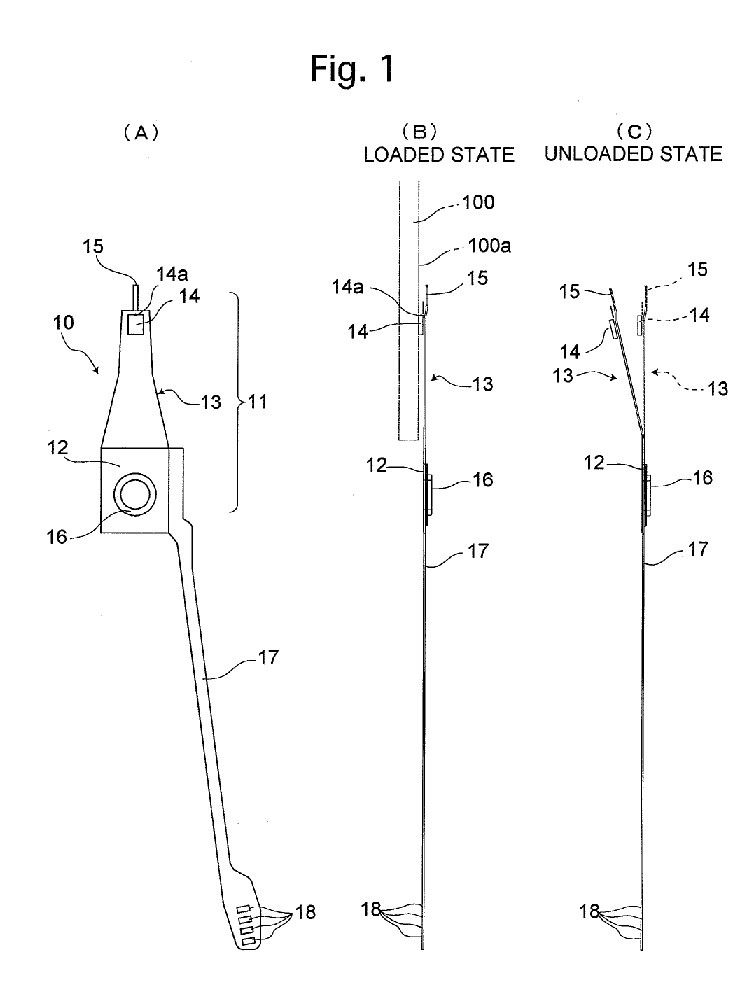

An HGA which is tested and measured by a spindle stage for testing a magnetic head according to the present invention is shown in FIG. 1, wherein (A) shows a front view, (B) shows a side view in a loaded state, and (C) shows a side view in an unloaded state.

Generally, the magnetic head of a hard disk drive is provided as an HGA which includes a slider with which a read/write elements are formed integral, and a load beam and a suspension arm which support this slider. The HGA 10 shown in the drawings is provided with a base plate 12, a load beam 13 and a slider 14 which are provided as elements of a suspension arm portion 11. The slider 14 is fixed to the tip of the load beam 13, and read/write elements 14a are integrated on formed integral with an end of the slider 14 which faces a medium. Additionally, a load/unload tab 15 having a raised portion is formed at the tip of the suspension arm portion 11 to project therefrom, and a swaging boss 16 for swaging the base plate 12 to a head arm (a actuator arm or a swing arm) is formed in the base plate 12. An FPC 17 is connected to reading/writing terminals (not shown) of the slider 14 which is connected to the read/write elements 14a, and the FPC 17 is drawn from the suspension arm portion 11 to extend rearward. The FPC 17 is provided at an end thereof with a set of electrical contacts 18 at which four contacts are exposed, wherein the four contacts come in contact with signal lines which are connected to the reading/writing terminals of the slider 14.

Servo writing is performed on a surface of a media 100, on a lower surface 100a in this particular embodiment, by a known servo writer or the like beforehand. For instance, a great number of tracks divided into predetermined sectors are written concentrically into the lower surface 100a of the medium 100. Additionally, a medium on which a servo pattern is prewritten can be used as the medium 100.

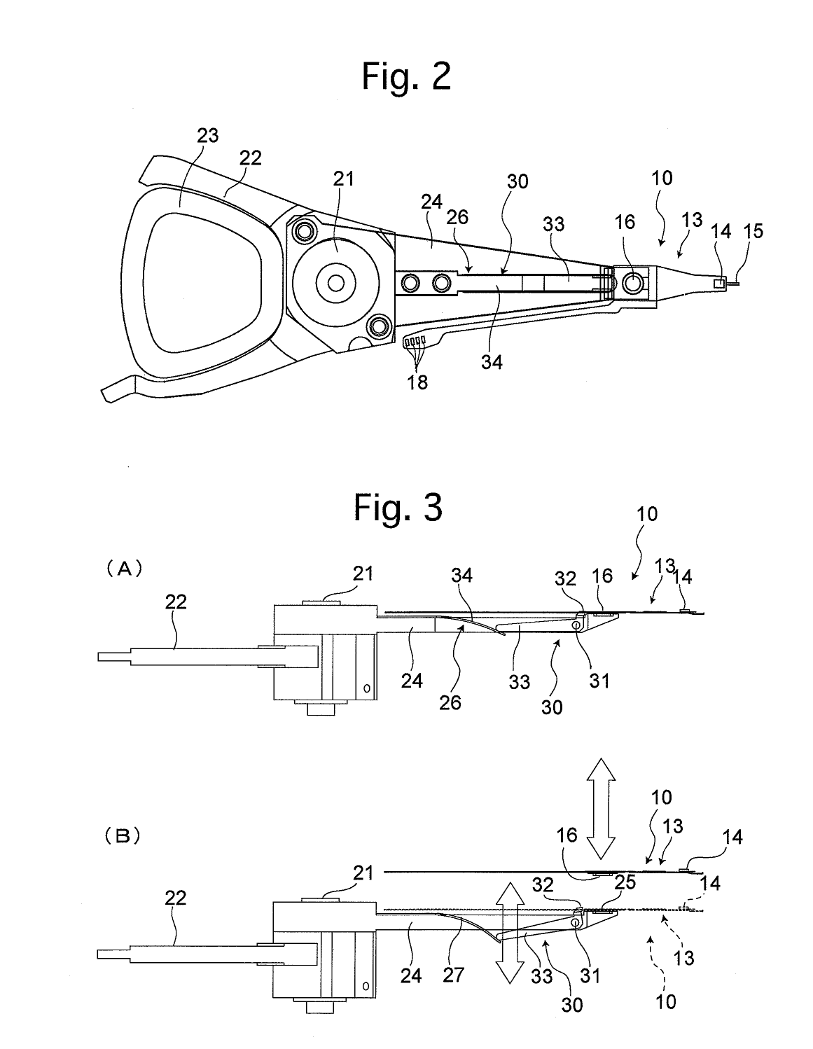

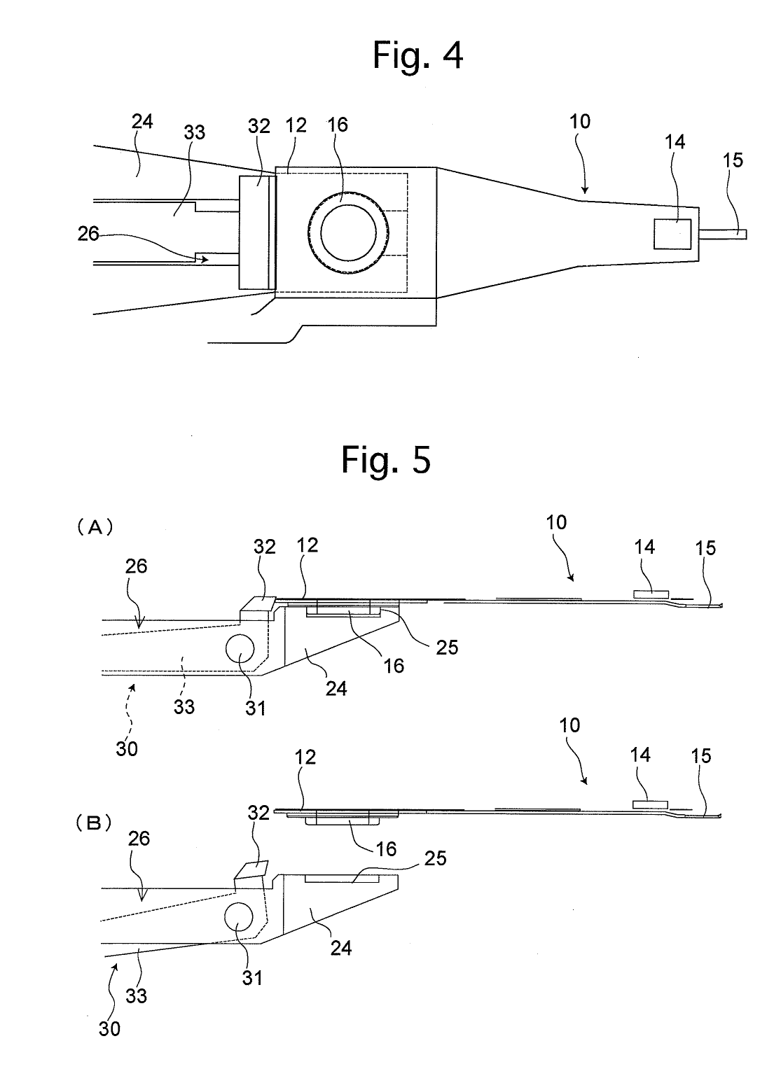

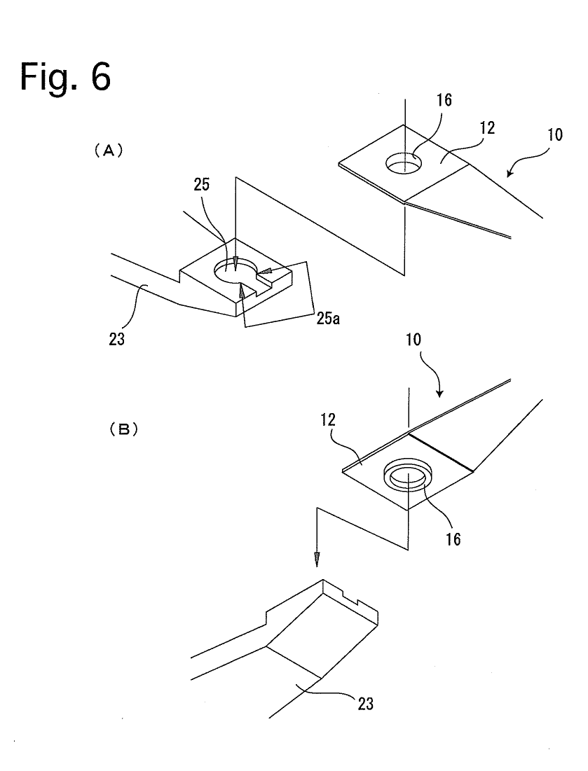

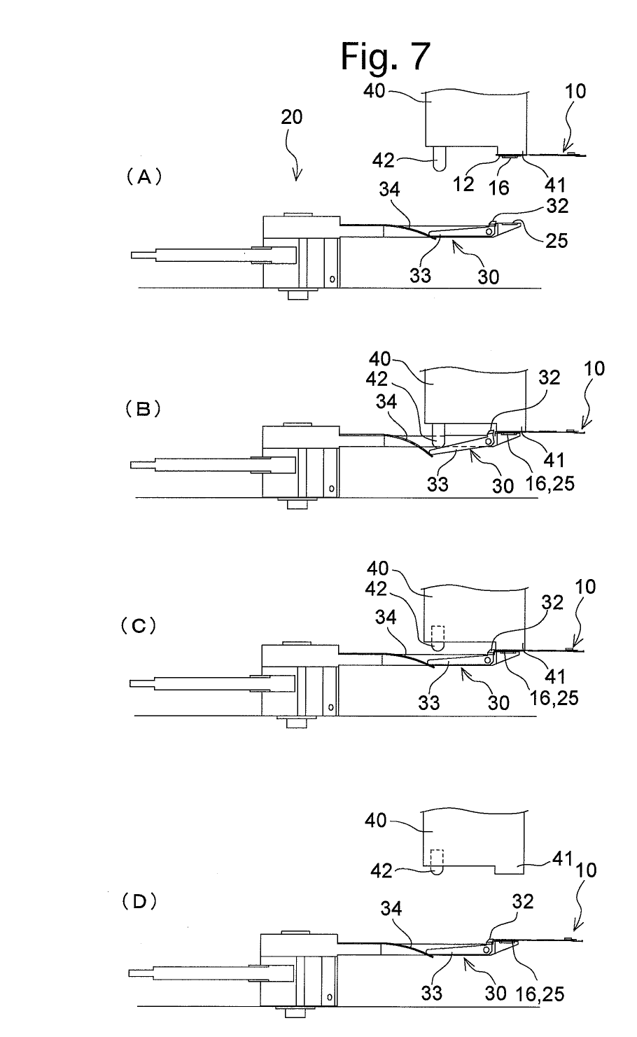

Subsequently, the structure of an embodiment of a VCM (Voice Coil Motor) mechanism which is mounted to the spindle stage for testing a magnetic head will be hereinafter discussed with reference to FIGS. 2 through 5. FIGS. 2 and 4 are plan views showing main parts of a head actuator, FIGS. 3(A) and 5(A) are side views showing the same, and FIGS. 3(B) and 5(B) show side views showing a state where the leaf spring of the head arm of the head actuator is depressed. FIG. 6 shows perspective views schematically showing the mounting/demounting structure between the head arm and the HGA, wherein (A) shows a perspective view viewed from above and (B) shows a perspective view viewed from below. FIGS. 4 and 5 show enlarged views of main parts shown in FIGS. 2 and 3.

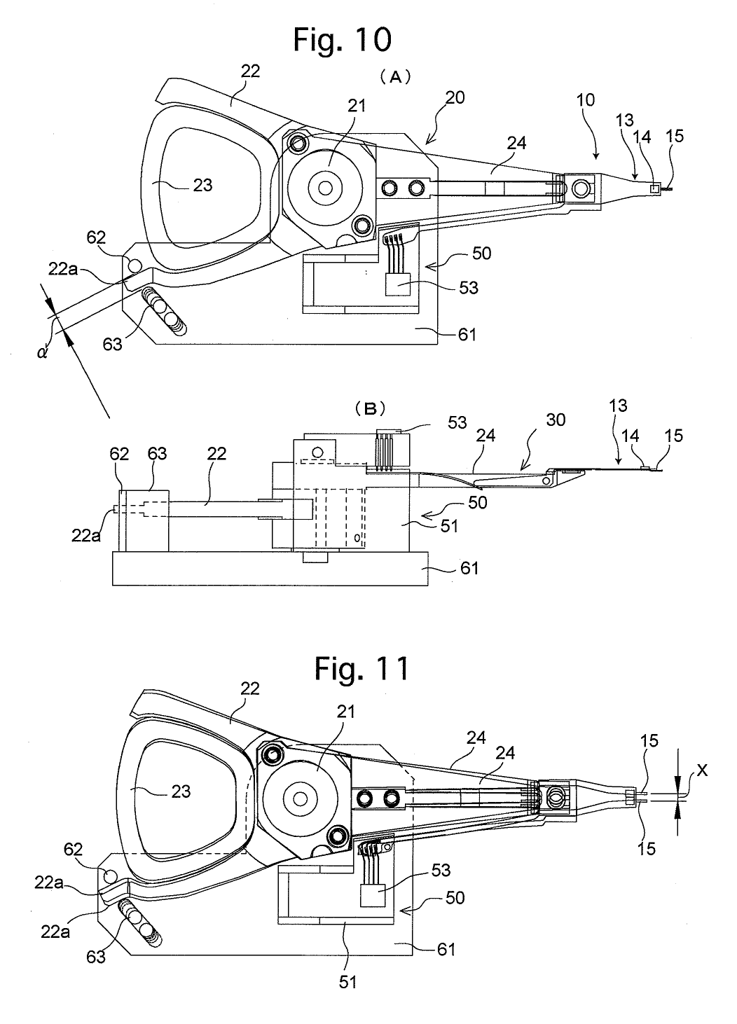

A head arm device 20 is provided with a bearing unit portion 21, a coil arm portion 22 and a head arm portion 24, wherein the coil arm portion 22 is formed integral with the bearing unit portion 21 and includes a voice coil 23, which constitutes a VCM mechanism, and the head arm portion 24 which extends in a direction opposite to the direction of extension of the coil arm portion 22. The bearing unit portion 21 is pivoted onto a movable base plate 61 to be freely rotatable (see FIGS. 10 through 12), permanent magnets (not shown) are arranged on the movable base plate 61 on opposite sides of the voice coil 23, and these elements constitute the VCM mechanism. In addition, although not shown in the drawings, a drive current is supplied to the voice coil 23 from a drive control circuit via an FPC to drive the head arm portion 24 so that it performs a track following operation.

The head arm portion 24 is provided in the vicinity of the tip thereof with a boss swaging hole 25 in which the swaging boss 16 of the HGA 10 is fitted. The head arm portion 24 is further provided between the bearing unit portion 21 and the swaging boss hole 25 with a rectangular opening 26 elongated in a radial direction, and a clamping lever 30 is fitted in the opening 26. The clamping lever 30 is pivoted to a shaft 31 to be freely swingable, wherein the shaft 31 extends in a direction tangent to a circle about the bearing unit portion 21. With this a pressure claw 32 is formed at the end of the clamping lever 30 in a radially outward direction from the shaft 31, and a lever 33 is formed on the clamping lever 30 on a portion thereof closer to the bearing unit portion 21 from the shaft 31. The length of the lever 33 is several times longer than the length from the shaft 31 to the pressure claw 32. The pressure claw 32 is positioned in the vicinity of the swaging boss hole 25, approaches the swaging boss hole 25 as the clamping lever 30 rotates clockwise (rightward rotation) with respect to FIG. 5, and moves away from the swaging boss hole 25 as the clamping lever 30 rotates counterclockwise (leftward rotation) with respect to FIG. 5.

Additionally, a leaf spring 34 which extends from the bearing unit portion 21 side is installed in the opening 26. The leaf spring 34 is in contact with the tip of the lever 33 to bias the clamping lever 30 continuously in a clamping direction (clockwise direction in the drawings) to make the pressure claw 32 approach the swaging boss hole 25. (A) in FIGS. 3 and 5 show a state where the pressure claw 32 of the clamping lever 30 rotated in the clamping direction (clockwise direction) by the biasing force of the leaf spring 34 presses the rear end surface of the suspension arm portion 11 (the rear end surface of the base plate 12), and (B) in FIGS. 3 and 5 show a state where the lever 33 is rotated in an unclamping direction (counterclockwise direction) against the biasing force of the leaf spring 34. The swaging boss 16 pressed by the pressure claw 32 is pressed against corners of the boss swaging hole 25 to get caught thereon, thereby being fixed to the boss swaging hole 25.

Operations for mounting and demounting the HGA 10 to and from the head arm device 20 in the present embodiment will be discussed hereinafter. Firstly, the lever 33 is pressed against the biasing force of the leaf spring 34 to rotate the clamping lever 30 in a releasing direction (FIG. 3(B) and FIG. 5(B)). In this released state, the swaging boss 16 of the HGA 10 is fitted into the boss swaging hole 25. Thereafter, upon a release of the pressure force of the clamping lever 30, the clamping lever 30 rotates in a locking direction by the biasing force of the leaf spring 34, the pressure claw 32 presses an end surface of the base plate 12 and engages therewith, and the swaging boss 16 is pressed against an inner wall in the boss swaging hole 25 to be fixed thereto (FIG. 3(A) and FIG. 5(A)).

Although the clamping lever 30 is biased to rotate by the leaf spring 34 in this embodiment, it is possible that the clamping lever 30 be biased to rotate by a torsion spring. The type of the spring to be used and the shape of the clamping lever 30 can be changed, desirably selected and changed according to the natural frequencies and weights of movable portions.

[Automatic Mounting/Demounting Device]

Subsequently, an automatic mounting/demounting device for mounting and demounting the HGA 10 to and from the head arm device 20 and the operation of the automatic mounting/demounting device will be hereinafter discussed with reference to FIG. 7. In this embodiment, by means of a loading head 40, the HGA 10 is sucked and held, lifted from a magnetic-head supply tray, moved onto the head arm portion 24 of the head arm device 20, and mounted to the head arm portion 24. Upon completion of testing/measurement, by means of the loading head 40, the HGA 10 is removed from the head arm portion 24 and brought into corresponding one of sorting trays which are sorted into, e.g., trays for defectives and non-defectives in accordance with results of the testing and measurement.

The loading head 40 is provided with a suction head 41 which removably sucks and holds the HGA 10, and a push pin 42 which presses the lever 33. The suction head 41 projects downwardly to a point below the lower surface of the loading head 40. Although not shown in the drawings, the suction head 41 is provided with a grooved portion or a positioning projection for determining the position of the HGA 10 relative to the loading head 40 when the base plate 12 of the HGA 10 is sucked and held. The loading head 40 is typically mounted to a robot arm (not shown) and moved horizontally and vertically between a tray and the HGA 10. An air suction head can be used as the suction head 41. In this case, it is desirable that the push pin 42 be also driven to project and retract by an air cylinder, a linear motor and an electromagnetic plunger.

Next, the operation of the loading head 40 will be hereinafter discussed with reference to (A) through (D) in FIG. 7. The loading head 40 which sucked and held the HGA 10 with the suction head 41 is moved until the swaging boss 16 is positioned immediately above the boss swaging hole 25 (FIG. 7(A)). At this time, the push pin 42 projects from a lower surface of the loading head 40.

The loading head 40 is made to descend so that the swaging boss 16 is fitted in the boss swaging hole 25. Thereupon, the push pin 42 depresses the lever 33 of the clamping lever 30 to rotate the lever 33 against the biasing force of the leaf spring 34 to move the pressure claw 32 to a releasing position where not to interfere with either the base plate 12 or the loading head 40. In this state, the swaging boss 16 is fitted in the boss swaging hole 25 (FIG. 7(B)).

Subsequently, the push pin 42 is drawn into the loading head 40 to release the lever 33. Thereupon, the biasing force of the leaf spring 34 causes the clamping lever 30 to rotate in an engaging direction so that the pressure claw 32 presses an end of the base plate 12 to fix the HGA 10 relative to the head arm portion 24 (FIG. 7(C)). Thereafter, the suction by the suction head 41 is released to release the HGA 10.

If the loading head 40 is made to ascend with the push pin 42 being drawn into the loading head 40 and with the suction by the suction head 41 being released, the HGA 10 comes to a state where the HGA 10 is fixedly mounted to the head arm device 20 (FIG. 7(D)).

When the HGA 10 is removed from the head arm device 20, the operations reverse to the above described mounting operations for mounting the HGA 10 to the head arm device 20 are performed. Namely, the suction head 41 starts sucking and holding the HGA 10 with the suction head 41 being in contact with the base plate 12 and a load/unload tab 15 (FIG. 7(C)) after the loading head 40 is made to descend onto the HGA 10 and the head arm device 20 after the state shown in FIG. 7(D), while the clamping lever 30 is rotated to a releasing position with the push pin 42 being projected from the loading head 40 (FIG. 7(B)). Thereafter, the loading head 40 is made to ascend with the suction head 41 sucking and holding the HGA 10 (FIG. 7(A)) and then moved to a predetermined tray.

As described above, according to the present invention, the HGA 10 can be easily installed and removed to and from the head arm device 20. Moreover, the seek/following capability does not deteriorate since both the total weight and the moment of inertia at swing motion of the head arm device 20 are small.

[Electrical Contact (Reading/Writing Signal Line) Connecting Structure]

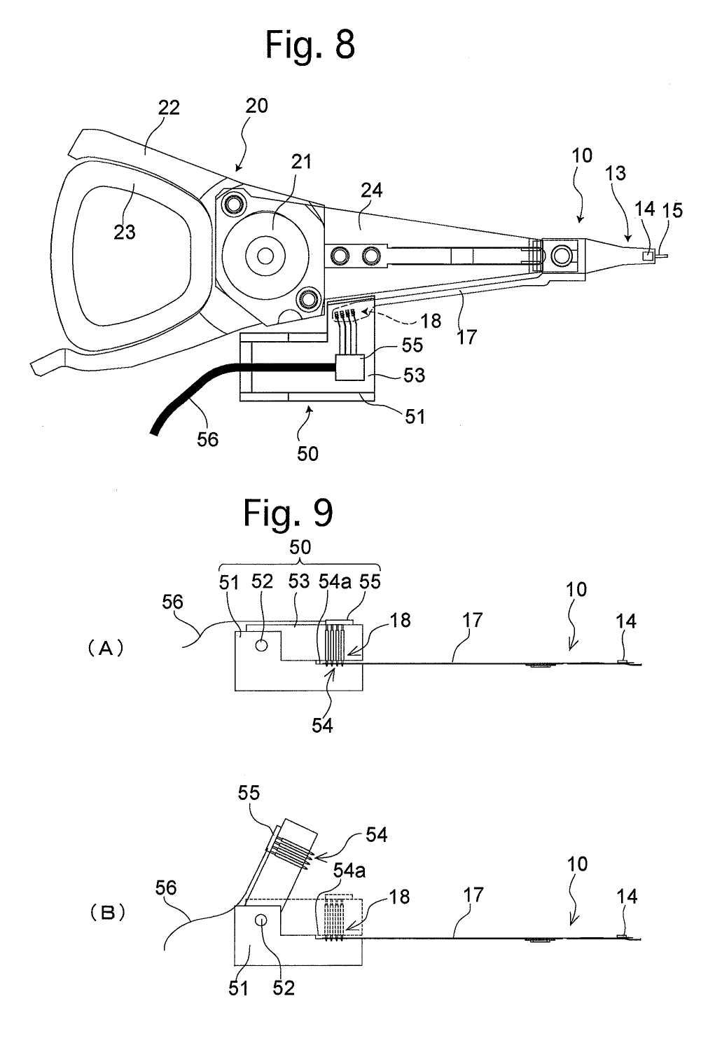

Subsequently, an embodiment of an electrical contact connecting structure for connecting the set of electrical contacts 18 (reading/writing signal lines and other signal line terminals) to a controller will be hereinafter discussed with reference to FIG. 8. In this embodiment, a weight reduction is achieved by a structure which connects the set of electrical contacts 18 of the HGA 10 to contacts provided outside of the head arm device 20.

A contact base 50 is disposed in the vicinity of the bearing unit portion 21, a mounting portion 51 on which the set of electrical contacts 18 are mounted is formed on the contact base 50, and a contact lever 53 which presses the mounting portion 51 is installed with the set of electrical contacts 18 being mounted on the mounting portion 51. The mounting portion 51 is formed into a U-shape in which the set of electrical contacts 18 are fitted to determine the position of the set of electrical contacts 18 and to prevent positional deviation of the set of electrical contacts 18.

The contact lever 53 is pivoted to the contact base 50 via a shaft 52 extending horizontally. The contact lever 53 is provided, on a surface thereof which faces the set of electrical contacts 18 on the mounting portion 51 on a side of the contact lever 53 in the vicinity of a free end of the contact lever 53, with a set of contacts 54 which correspond to the set of electrical contacts 18 on the mounting portion 51, and the contact lever 53 is formed so that the set of contacts 54 comes into pressing contact with the corresponding set of electrical contacts 18 to be electrically continuous thereto upon compressing the set of contacts 54. A recessed guide portion 54a which can determine the position of the set of electrical contacts 18 is formed on the mounting portion 51.

In addition, a head amp 55 contained on an FPC 56 is mounted on the contact lever 53, and the set of contacts 54 is connected to an input terminal of the head amp 55. Additionally, the FPC 56 is drawn from the contact lever 53 to be connected to a control circuit of a testing device.

The contact lever 53 is formed to be capable of rotating between a connecting position (FIG. 9(A)) in which the contact lever 53 compresses the set of electrical contacts 18 and a disconnecting position in which the set of electrical contacts 18 are released (FIG. 9(B)). Additionally, it is desirable that the contact base 50 be equipped with a driving device such as an electromagnetic actuator, an air cylinder or the like which rotates the contact lever 53 between the connecting position and the disconnecting position.

As described above, according to the electrical contact connecting structure, a weight reduction of a movable portion of the head arm device 20 is achieved since the contact base 50 is provided outside of the head arm device 20 and also the set of electrical contacts 54 and the head amp 55 are provided on the contact base 50.

[Two-Stage Actuator Mechanism]

In the electrical contact connecting structure shown in FIGS. 8 and 9, the FPC 17 is elastically deformed when the head arm portion 24 of the head arm device 20 rotates. Namely, the range of rotation of the head arm portion 24 is limited within the range of elastic deformation of the FPC 17. Therefore, it is difficult to rotate the head arm portion 24 between a loading position and an unloading position located outside of the medium 100. For this reason, the present embodiment according to the present invention is configured such that the head arm device 20 and the contact base 50 are moved between the unloading position and the loading position by a coarse-moving actuator 60 and that the head arm portion 24 is rotated through a minute angle of rotation by control of a power supply to the voice coil 23 of the head arm device 20 when the head arm device 20 and the contact base 50 are in the loading position.

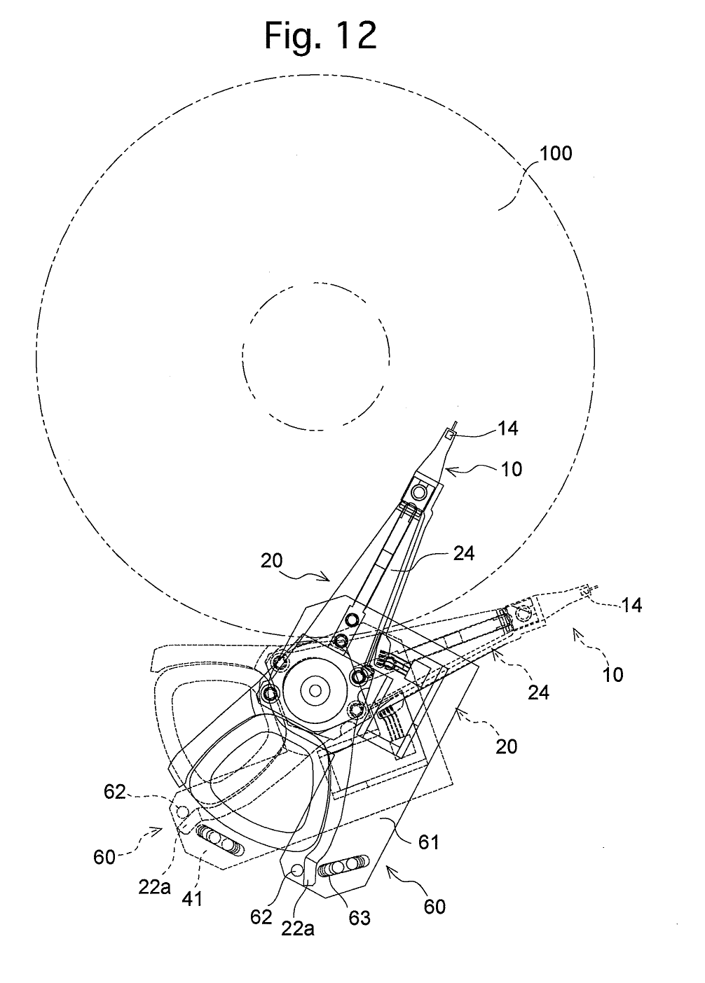

The present embodiment is configured such that the head arm device 20 and the contact base 50 are mounted on the movable base plate 61 of the coarse-moving actuator 60, that loading and unloading operations are carried out by movements of the movable base plate 61 and that the range of swing movement of the head arm portion 24 by the voice coil 23 is limited within a swing angle that is a following range (movable distance x) required for testing/measurement of the slider 14. The swing angle is sufficient if the degree thereof allows the head arm portion 24 can follow a few tracks to several tens of tracks. An embodiment of the coarse-moving actuator mechanism according to the present invention which realizes this configuration will be hereinafter discussed with reference to FIGS. 10 through 12. In FIG. 10, (A) is a plan view and (B) is a side view. FIG. 11 is a plan view illustrating the range of movement of the head arm device 20, and FIG. 12 is a plan view showing a manner of moving the head arm device 20 and the contact base 50 between the loading position and the unloading position.

The head arm device 20 and the contact base 50 are installed on the movable base plate 61 having the shape of a letter L in plan view. The head arm device 20 is pivoted to be freely rotatable with a shaft 21a which projects from the lower end of the bearing unit portion 21 being inserted into a bearing formed in the movable base plate 61. The contact base 50 is fixed on the movable base plate 61.

The movable base plate 61 is supported by a base frame 110 of a testing device to be freely swingable through the shaft 65a that is concentric with the shaft 61a. The movable base plate 61 rotates between the unloading position and the loading position by a rotary actuator 65 via the shaft 65a that serves as a rotary shaft of the rotary actuator 65. The rotary actuator 65 can be an electromagnetic actuator or an air actuator, or an electromagnetic-piston or an air-piston cylinder mechanism.

Additionally, although there is only one loading position where the slider 14 is loaded by the coarse-moving actuator 60 in the above illustrated embodiment, more than one loading position can be provided, or it is possible that the slider 14 be loaded at a position designated by the user.

Next, a structure which limits the range of rotation of the head arm portion 24 to an angle α will be discussed hereinafter. A limit projection 22a which projects from one end of the coil arm portion 22 is positioned between a fixed limit pin 62 fixed on the movable base plate 61 and a movable limit pin 63. Accordingly, the range of rotation of the coil arm portion 22 is limited within an angular range in which the limit projection 22a comes in contact with the fixed limit pin 62 and the movable limit pin 63, i.e., within the angle α. If the coil arm portion 22 rotates at the angle α, the slider 14 (the read/write elements 14a) of the HGA 10 that is mounted to the head arm portion 24 moves in a radial direction of the medium 100 in a circumferential direction about the bearing unit portion 21 by a distance x. The distance x is a distance allowing the slider 14 to move between a plurality of tracks of the medium 100, and is a few tens of micrometers if adapted to the current typical track density. Due to this limitation of the rotational range of the head arm portion 24, the amount of elastic deformation of the FPC 17 can be small and there is no possibility of the set of electrical contacts 18 being disengaged from the mounting portion 51.

Additionally, the movable limit pin 63 is formed to be capable of moving toward and away from the fixed limit pin 62, and this movement of the movable limit pin 63 toward and away from the fixed limit pin 62 makes it possible to adjust the movable angle, i.e., the movable distance x when the slider 14 is made to perform a following operation.

FIG. 12 shows a plan view showing a manner of moving the head arm device 20 between the loading position and the unloading position. When the HGA 10 is mounted and demounted to and from the head arm device 20, the movable base plate 61 is rotated and held in the unloading position that is indicated by broken lines. In the unloading position, the HGA 10 is mounted and demounted by the loading head 40.

Upon the HGA 10 being mounted to the head arm device 20, the movable base plate 61 is rotated to the loading position, and the HGA 10 is held at a position facing a predetermined track of the medium 100. The solid lines in the drawings represent the loading position. In this loading position, a testing/measuring operation for the HGA 10 is performed. The track following operation of the head arm device 20 is controlled within the range of the rotating angle in which the range of movement of the limit projection 22a is defined by the fixed limit pin 62 and the movable limit pin 63.

Upon completion of the testing/measuring operation, the coarse-moving actuator 60 rotates to the unloading position, the HGA 10 is removed from the head arm device 20 by the loading head 40, and another HGA 10 is mounted to the head arm device 20.

As described above, in the above illustrated embodiment according to the present invention, a following control sufficient for the testing/measuring operation for the HGA 10 can be carried out even if the range of movement of the head arm device 20 is limited by the FPC 17 since the coarse-moving actuator 60 for moving the head arm device 20 entirely between the unloading position and the loading position is provided and since a following operation is performed after the head arm device 20 is moved to the loading position by the coarse-moving actuator 60.

[Ramp Structure]

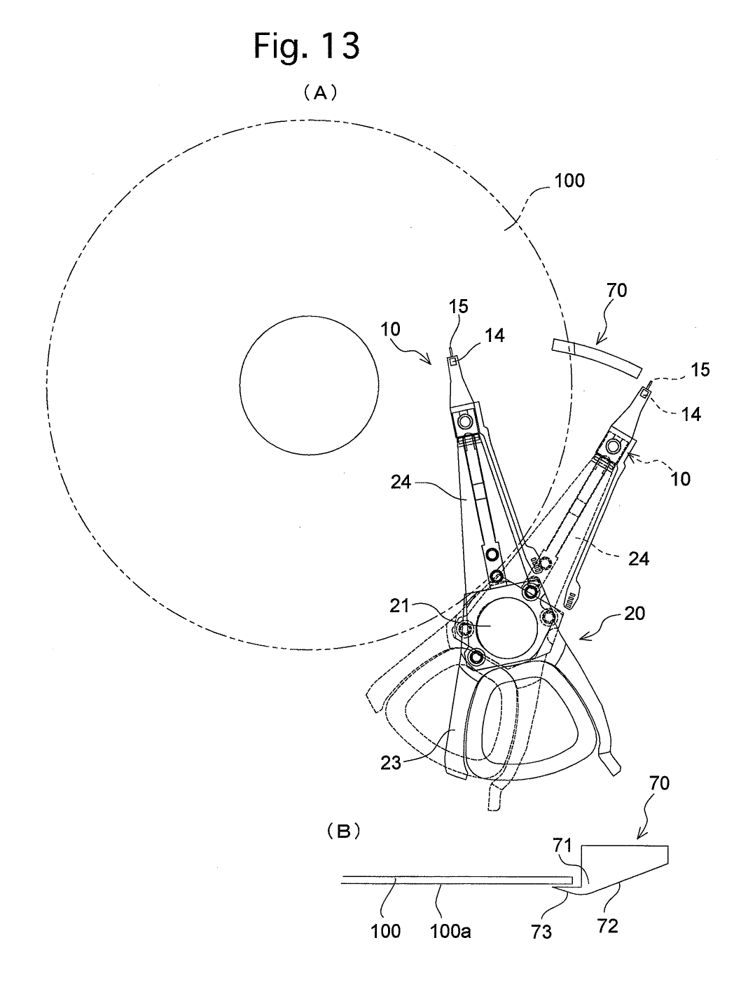

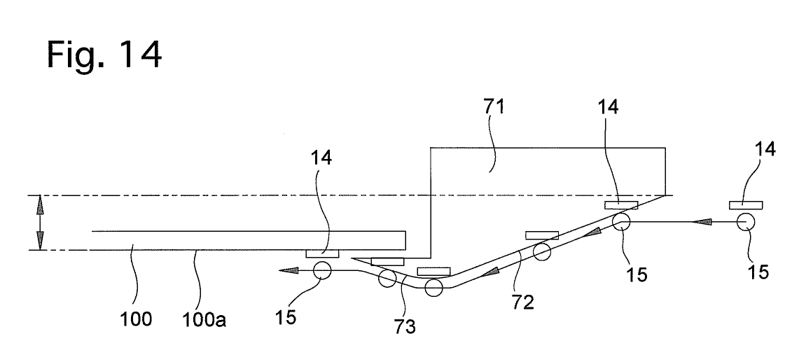

The embodiment shown in FIG. 12 is configured so that the slider 14 is positioned on a top surface of the head arm device 20 and loaded to the lower surface 100a of the medium 100. Additionally, the HGA 10 is formed so that the suspension of the suspension arm portion 11 bends when the HGA 10 is in the unloading position. Therefore, even if the slider 14 is attempted to rotate from the unloading position to the loading position, the suspension arm portion 11 comes into contact with the periphery of the medium 100, which makes the slider 14 impossible to be loaded. Accordingly, the present embodiment according to the present invention is provided with a ramp structure for loading/unloading the slider 14. An embodiment of the ramp structure according to the present invention will be hereinafter discussed with reference to FIGS. 13 and 14.

This ramp block 70 is of a type which loads the slider 14 to the lower surface 100a of the medium 100. The ramp block 70 is provided with a block 71 disposed in the vicinity of the periphery of the medium 100. The ramp block 70 is provided on a lower surface thereof with a first slope surface 72 and a second slope surface 73, wherein the first slope surface 72 descends on the outside of the medium 100 in a direction from a point higher than the lower surface 100a of the medium 100 toward the center of the medium 100 to enter below the lower surface 100a of the medium 100 while the second slope surface 73 ascends to a small extent from the lowest point of the first slope surface 72. The first slope surface 72 and the second slope surface 73 are smoothly continuous to each other and formed along the moving path of the load/unload tab 15 to have an arc shape in plan view about the center of rotation of the bearing unit portion 21 (FIG. 13(A)).

When the head arm portion 24 has rotated to the unloading position, the slider 14 and the load/unload tab 15 are positioned outside of the ramp block 70 far beyond the ramp block 70. Although the suspension arm portion 11 bends upwardly by the resiliency thereof, the load/unload tab 15 is positioned at a position below the first slope surface 72. If the head arm portion 24 rotates from this unloading position toward the loading position, firstly the load/unload tab 15 comes into contact with the first slope surface 72. Thereafter, the load/unload tab 15 is depressed against the resiliency of the suspension arm portion 11 while sliding on the first slope surface 72 to be positioned at a position below the lower surface 100a of the medium 100. If the head arm portion 24 further rotates toward the loading position, the load/unload tab 15 moves from the first slope surface 72 to the second slope surface 73 and gradually ascends along the second slope surface 73 by the resiliency of the load beam 13, and then the slider 14 reaches the lower surface 100a of the medium 100 to be held with a predetermined distance between the slider 14 and the lower surface 100a. Thereafter, the load/unload tab 15 moves away from the second slope surface 73, and the slider 14 moves toward the loading position while maintaining the predetermined distance between the slider 14 and the medium 100. In a state where the head arm portion 24 has reached the loading position, the slider 14 is held at a predetermined distance from the lower surface 100a of the medium 100, and the head arm portion 24 is held to be freely swingable within the angle.

If the head arm portion 24 rotates from this loading position toward the unloading position, firstly the load/unload tab 15 comes into contact with the second slope surface 73 and moves toward the unloading position, which is positioned radially outside of the medium 100, while sliding on the second slope surface 73. In the course of this movement, the load/unload tab 15 moves away from the lower surface 100a of the medium 100. If the head arm portion 24 further rotates toward the unloading position, the load/unload tab 15 moves from the second slope surface 73 to the first slope surface 72, ascends along the first slope surface 72 by the resiliency of the suspension arm portion 11, and moves away from the first slope surface 72 to reach the unloading position. In the unloading position, the slider 14 and the HGA 10 are sufficiently apart from the ramp block 70 and become possible to be freely mounted and demounted to and from the head arm device 20.

[Up/Down (Upper-Surface/Lower-Surface Loading)-Capable Mechanism]

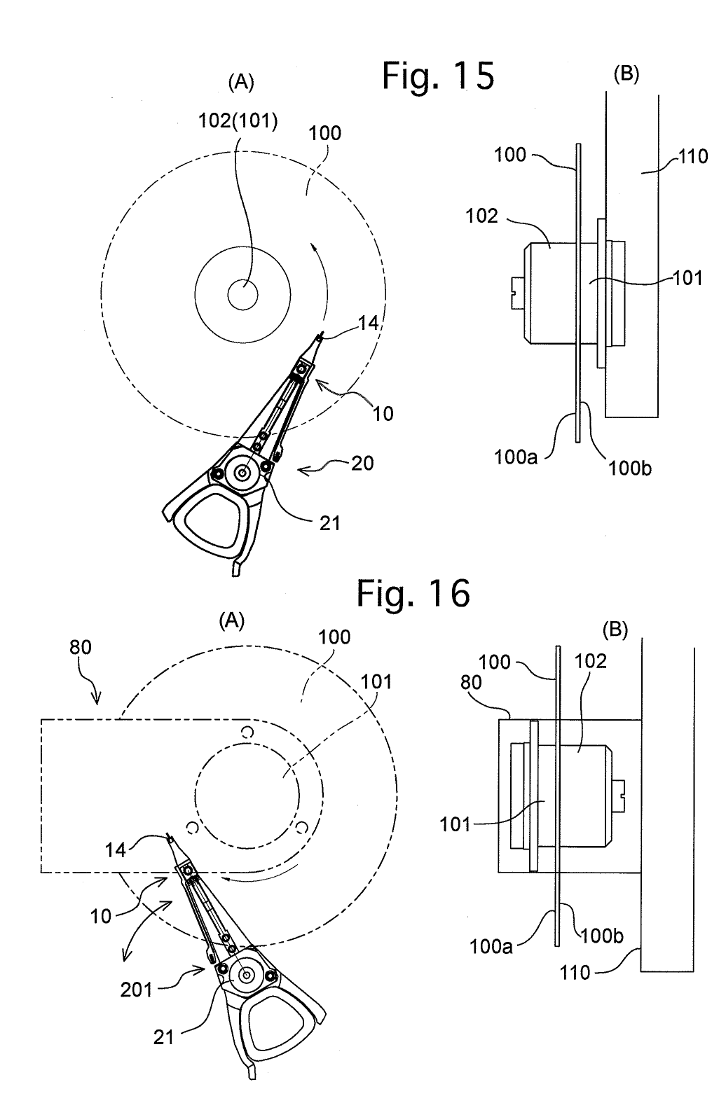

The above described embodiment is a spindle stage which is used for testing a magnetic head and loads a magnetic head, i.e., the slider 14 of the HGA 10 to the lower surface 100a of the medium 100. In FIG. 15, (A) shows a plan view and (B) shows a view viewed from right side.

In the head arm device 20 for lower-surface loading, a spindle motor 101 is fixed onto the base frame 110, and the medium 100 is fixed to a spindle shaft 102 of the spindle motor 101. The spindle motor 101 rotates counterclockwise (leftward rotation) with respect to FIG. 15(A).

In normal hard disk drives, a magnetic head is installed to hold both sides of the medium 100. Although a slider and an HGA which are used to be loaded to the upper surface of the medium 100 are identical in specification to the slider 14 and the HGA 10, respectively, the outer and inner regions of the slider relative to the medium 100 are reverse to those of the slider 14. Therefore, in the spindle stage for testing a magnetic head shown in FIGS. 12 through 15, a characteristic test for testing characteristics of the HGA which is to be loaded to the upper surface of the medium 100 cannot be performed with precision.

FIG. 16 shows an embodiment of a spindle stage which is used for testing a magnetic head and which can automatically mount and demount the HGA which is to be loaded to the upper surface of the medium 100 from above with the use of the loading head 40 to perform the characteristic test with precision.

In FIG. 16, (A) is a plan view and (B) is a view viewed from right side.

In the embodiment of the head arm device 20 for lower-surface loading, the spindle motor 101 is fixed onto the base frame 110, and the medium 100 is fixed to a spindle shaft of the spindle motor 101. The spindle motor 101 rotates counterclockwise (leftward rotation) with respect to FIG. 15(A).

In contrast, the embodiment of the head arm device 201 for upper-surface loading is configured so that the arrangement of the spindle motor 101 and the medium 100 that are arranged on the base frame 110 is vertically reversed. Namely, the medium 100 and the spindle motor 101 are vertically reversed and fixed to a U-shaped yoke 80 so as to hang from an upper stretch portion of the U-shaped yoke 80. The driving direction of the spindle motor 101 and the drive control therefore are identical to those shown in FIG. 15, and accordingly, the medium 100 rotates clockwise (rightward rotation) in this embodiment.

The head arm device 201 for upper-surface loading (FIG. 16(A)) is different from the head arm device 20 in that the head arm device 20 for lower-surface loading (FIG. 15(A)) is formed so that the outside of the downstream side in the direction of rotation of the medium 100 (the right side of a straight line in a radial direction which passes through the spindle shaft 102 and the center of the bearing unit portion 21) becomes the unloading position, whereas the head arm device 201 for upper-surface loading (FIG. 16(A)) is arranged so that the outside of the downstream side in the direction of rotation of the medium 100 (the left side of a straight line in a radial direction which passes through the spindle shaft 102 and the center of the bearing unit portion 21) becomes the unloading position and so that the head arm device 201 rotates clockwise and counterclockwise (leftward rotation) at the time of loading and unloading, respectively. Mounting and demounting of the HGA are carried out from above, similar to the head arm device; however, the head arm device 20, the clamping lever 30 and the contact base 50 can be used for both upper-surface loading and lower-surface loading. The shape and movements of the coarse-moving actuator 60 and the ramp block are determined in accordance with the loading/unloading direction.

As described above, according to the head arm device 201 for upper-surface loading, the HGA 10 for upper-surface loading can be mounted and demounted to and from the head arm portion 24, similar to the HGA 10 for lower-surface loading, thus being capable of being mounted, demounted and transferred by the loading head 40 shown in FIG. 7. Since the spindle motor 101 and the medium 100 are vertically reversed, it is no longer necessary to prepare either a spindle motor or a medium for rightward rotation. The cost of components can be reduced since the head arm device 20 and the contact base 50 of the same specifications can be used for both the spindle stage for loading a magnetic head to the lower-surface of a medium and the spindle stage for loading a magnetic head to the upper-surface of a medium.

If the spindle stage for testing a magnetic head which incorporates the head arm device 20 for lower-surface loading and the spindle stage for testing a magnetic head which incorporates the head arm device 201 for upper-surface loading are arranged side by side, the HGA for upper-surface loading and the HGA for lower-surface loading can be tested and measured in tandem with each other, which makes it possible to achieve a reduction in cost and a reduction in time required for the testing and measurement.

### INDUSTRIAL APPLICABILITY

According to the present invention, the HGA can be easily mounted and demounted to and from the head arm portion with no increase in weight of the head arm portion because the HGA can be easily mounted and demounted to and from the head arm portion and locked by a clamping member.

A high-precision servo following operation is achieved at a low cost because a VCM mechanism is used.

According to an invention regarding a device for automatically mounting/demounting a magnetic head, an HGA can be picked up from a supply tray and mounted to a head arm portion by a simple-structured loading head. Moreover, the magnetic-head mounting and demounting operation can be easily automated with no need for manpower since the structure for mounting and demounting the HGA is simple.

While the present invention has been illustrated and described with respect to a particular embodiment thereof, it should be appreciated by those of ordinary skill in the art that various modifications to this invention may be made without departing from the spirit and scope of the present invention.

What is claimed is:

1-9. (canceled)

10. A spindle stage for testing a magnetic head, which includes:
a head arm device having a head arm portion which is driven to swing by a VCM mechanism; and an HGA (head gimbal assembly) mounted to said head arm portion, and loads said head arm device and said HGA relative to a surface of a medium in rotation to measure electrical and mechanical characteristics, wherein said spindle stage is characterized in that said spindle stage comprises:
a fitting portion in which a swaging boss of said HGA is removably fitted; and
a clamping member which moves between a locking position in which said swaging boss fitted in said fitting portion is locked and a releasing position in which said swaging boss can be freely fitted and removed into and from said fitting portion.

11. The spindle stage for testing a magnetic head according to claim 10, wherein said clamp member comprises a clamp lever having a claw portion formed to be movable between a releasing position in which said HGA is allowed to be mounted and demounted and an engaging position in which said claw portion engages with said HGA to lock said swaging boss relative to said fitting portion, and
wherein said clamp lever comprises a resilient member which biases said claw portion to rotate in a direction toward said engaging position.

12. The spindle stage for testing a magnetic head according to claim 10, further comprising a contact base on which a plurality of electrical contacts are mounted, said plurality of electrical contacts being arranged at one end of an FPC drawn from said HGA installed to said head arm portion,
wherein said contact base comprises a contact lever which is movable between a connecting position in which said contact lever holds said plurality of electrical contacts and a disconnecting position in which said contact lever is disengaged from said plurality of electrical contacts, and
wherein said contact lever comprises a plurality of electrical contacts which are connected to said plurality of electrical contacts arranged at said one end of said FPC.

13. The spindle stage for testing a magnetic head according to claim 11, further comprising a movable base plate on which said head arm device and said contact base are mounted,
wherein said movable base plate moves said head arm device and said contact base as one piece between an unloading position in which said HGA is unloaded outside of said medium and a loading position in which said HGA is loaded on said medium.

14. The spindle stage for testing a magnetic head according to claim 13, wherein said head arm device further comprises a limit mechanism for limiting the range of movement of said VCM mechanism.

15. The spindle stage for testing a magnetic head according to claim 14, wherein said limit mechanism is composed of a limit projection which projects from a coil arm portion to which said VCM mechanism is mounted, and two limit members arranged on opposite sides of said coil arm portion, at least one of said two limit members being formed to be movable in a direction to adjust said range of movement of said VCM mechanism.

16. The spindle stage for testing a magnetic head according to claim 13, further comprising a ramp member having a ramp surface,
wherein said ramp surface makes a tip of said HGA move onto said ramp surface and moves said magnetic head gradually away from a surface level of said medium in rotation before said magnetic head moves off said medium when said movable base plate moves in a direction toward said unloading position, makes said tip move off said medium and move away from said ramp surface when said movable base plate is in said unloading position, makes said tip move onto said ramp surface and moves said magnetic head in a direction away from said surface of said medium before said magnetic head reaches said surface of said medium when said movable base plate moves from said unloading position toward said loading position, and thereafter makes said magnetic head gradually approach said surface of said medium and subsequently move away from said ramp surface before reaching said loading position.

17. An automatic magnetic head mounting/demounting device applied to said spindle stage for testing a magnetic head according to one of claim 10, wherein said automatic magnetic head mounting/demounting device comprises a loading head including:
a suction portion which sucks and holds said HGA to be capable of freely holding/releasing said HGA; and
a release member which presses said clamp member of said head arm portion to rotate said clamp member to said releasing position against said resilient biasing member,
wherein said loading head is configured so that said release member presses said clamp member against said resilient biasing member to rotate said clamp member in said releasing position before said loading head makes said HGA which is sucked and held by said suction portion fitted into said fitting portion, so that said release member releases said clamp member to thereby rotate said clamp member to an engaging position by a biasing force of a resilient biasing member to lock said HGA by a locking portion, and so that said suction portion stops sucking and holding said HGA to be disengaged therefrom.
